(19) United States
(12) Patent Application Publication
(10) Pub. No.: US 2011/0183306 A1
(43) Pub. Date: Jul. 28, 2011

(54) SENSING AND INCENTIVIZING BEHAVIORAL ACTIONS

(76) Inventor: Brian Krejcarek, Portland, OR (US)

(21) Appl. No.: 13/015,325

(22) Filed: Jan. 27, 2011

Related U.S. Application Data
(60) Provisional application No. 61/299,251, filed on Jan. 28, 2010.
(60) Provisional application No. 61/310,189, filed on Mar. 3, 2010.
(60) Provisional application No. 61/351,734, filed on Jun. 4, 2010.
(60) Provisional application No. 61/459,235, filed on Dec. 9, 2010.

(51) Int. Cl. G09B 19/00

(52) U.S. Cl. 434/238

(57) ABSTRACT

Various embodiments are described herein related to positively reinforcing a behavioral action based on information received from sensors configured to detect the action. For example, one disclosed embodiment relates to a method for positively reinforcing a user behavior includes, at a server computing device, receiving behavior data from a sensor configured to sense a user behavioral action. Responsive to the behavior data, the method further includes using a logic subsystem of the server computing device to supply an offer configured to reward the user behavioral action and sending the offer to the user.

### CROSS REFERENCE TO RELATED APPLICATIONS

This application claims priority to U.S. Provisional Patent Application Ser. No. 61/299,251, titled “Sensing and Incentivizing Energy-Saving Behavior” and filed on Jan. 28, 2010; to U.S. Provisional Patent Application Ser. No. 61/310,189, titled “Sensor Network for a Behavior Reward System” and filed on Mar. 3, 2010; to U.S. Provisional Patent Application Ser. No. 61/351,734, titled “Sensor Network for a Behavior Reward System” and filed on Jun. 4, 2010; and to U.S. Provisional Patent Application Ser. No. 61/459,235, titled “Personal Activity Measurement and Behavior Storage Device and Methods to Achieve Very Low Power and Low Cost,” and filed on Dec. 9, 2010, the entireties of which are hereby incorporated herein by reference for all purposes.

### BACKGROUND

Making changes to personal habits can be difficult. Some approaches use rigorous tracking. For example, an individual may track her behavior in a journal, logging activities to be encouraged or discouraged, so that she may review her progress over time. However, such approaches can be tedious, leading to neglect and avoidance of the behavior, so that the individual may fall back into her previous behavioral pattern. Further, tracking and logging behaviors may inhibit behavioral change where the changes are incrementally small and where the individual is discouraged by the apparent lack of progress.

### SUMMARY

Various embodiments are described herein related to positively reinforcing a behavioral action based on information received from sensors configured to detect the action. For example, one disclosed embodiment relates to a method for positively reinforcing a user behavior. The method includes, at a server computing device, receiving behavior data from a sensor configured to sense a user behavioral action. Responsive to the behavior data, the method further comprises using a logic subsystem of the server computing device to supply an offer configured to reward the user behavioral action, and sending the offer to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an embodiment of a behavior reward system.

FIG. 2A shows a portion of a flow chart illustrating an embodiment of a method of reinforcing a user behavior based on behavioral action data received from a sensor.

FIG. 2B shows another portion of the flow chart of FIG. 2A.

FIG. 3 schematically shows an embodiment of a sensor for use with the behavior reward system of FIG. 1.

### DETAILED DESCRIPTION

As explained above, making changes to personal habits can be difficult. Tracking and logging behaviors may inhibit behavioral change where the changes are incrementally small and where the individual is discouraged by the apparent lack of progress. Thus, various embodiments of methods and hardware are described herein that relate to positively reinforcing a behavioral action based on information received from sensors configured to detect the action. For example, in one embodiment, a method for positively reinforcing a user behavior comprises, at a server computing device, receiving behavior data from a sensor configured to sense a user behavioral action. Responsive to the behavior data, the method further comprises using a logic subsystem of the server computing device to supply an offer configured to reward the user behavioral action and sending the offer to the user.

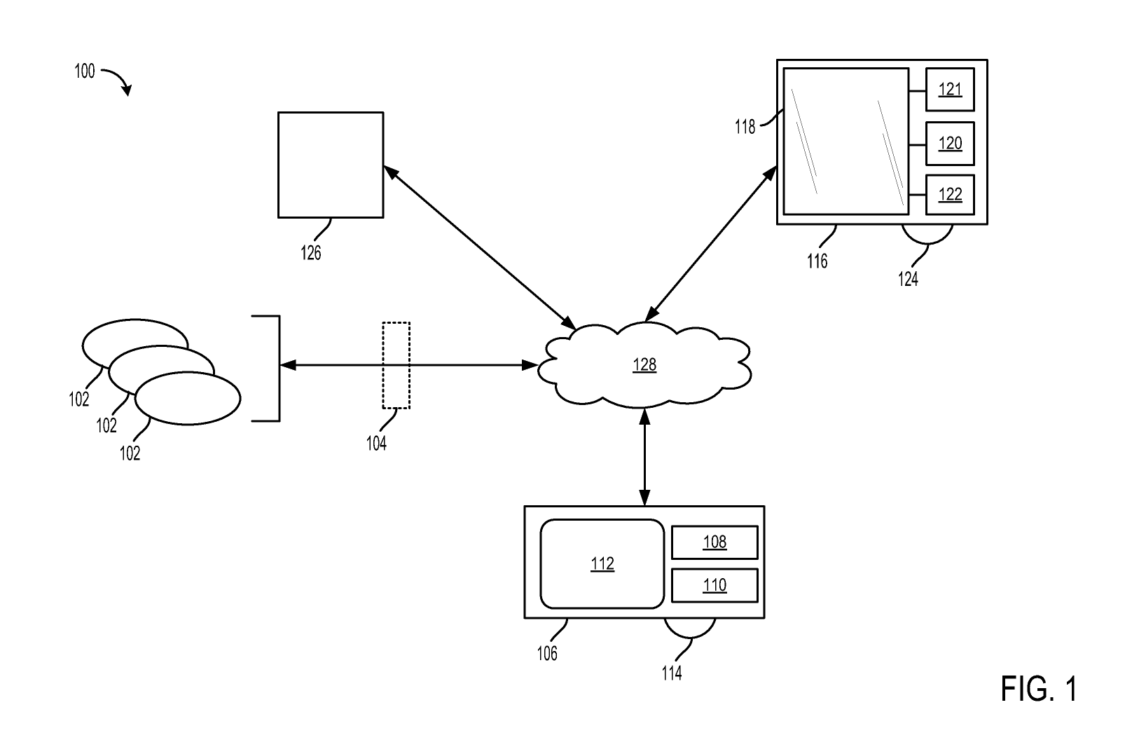

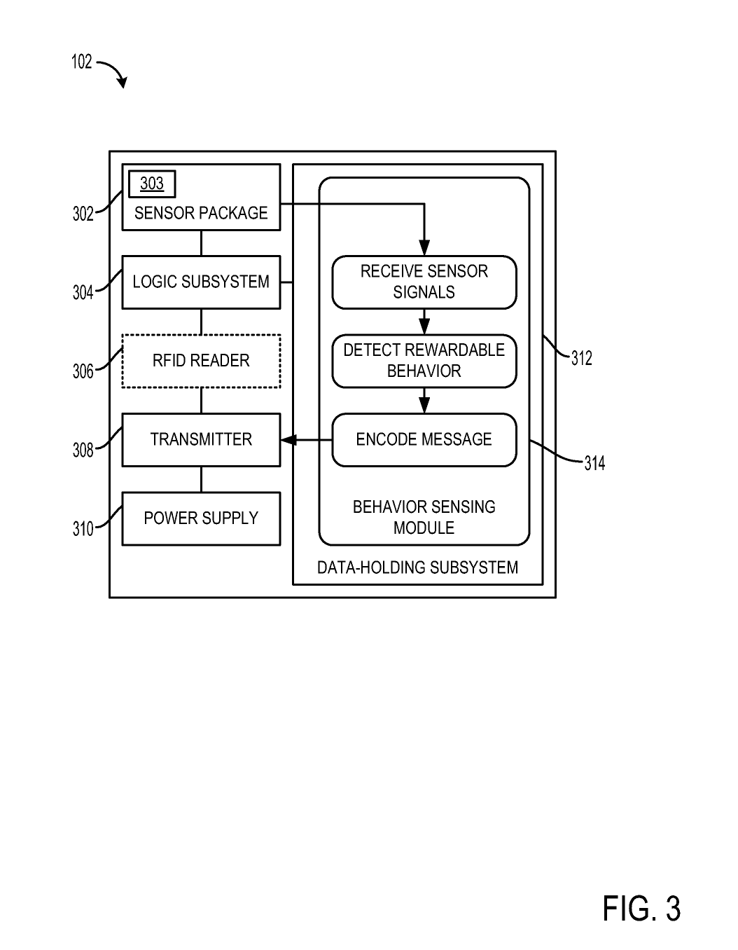

For example, FIG. 1 schematically shows an embodiment of a behavior reward system 100. Behavior reward system 100 comprises a plurality of sensors 102 configured to detect a user behavioral action and transmit messages related to the user behavioral action to server computing device 106. Example sensors will be described in more detail below with respect to FIG. 3.

In some embodiments, an optional gateway computing device 104 may relay messages between sensors 102 and server computing device 106. For example, in some embodiments, gateway computing device 104 may be configured to communicate with various sensors 102 installed in and around a user's residence via wireless and/or wired communication. Further, in some embodiments, gateway computing device 104 may be configured to provide location information for one or more sensors 102, such as by providing a media access control (MAC) address registered to a particular physical location.

Server computing device 106 manages behavior reward system 100, and may include one or more servers and/or a cloud computing environment. Server computing device 106 includes a logic subsystem 108, a data-holding subsystem 110, and is configured to read from and/or write to removable computer readable media 114. The logic subsystem 108 is configured to execute instructions stored in the data-holding subsystem 110 to implement instructions for performing the various methods described herein.

Server computing device 106 includes a behavior reward module 112, behavior reward module 112 being implemented via instructions stored in data-holding subsystem 110 and executed by logic subsystem 108. Behavior reward module 112 is configured to receive behavioral action data from sensors 102, supply an offer responsive to the behavioral action data, and send the offer to client computing device 116 for presentation to the user.

Behavior reward module 112 may be configured to send portions of the behavioral action data to, and/or to receive offers and offer-related messages from, one or more offering parties 126. Offering parties 126 are parties who choose to provide a reward and/or an incentive to the user in response to the user's behavioral action. Some non-limiting examples of offering parties 126 include employers, social affiliates, and goods and services providers. For example, in one scenario, an offering party 126 may be the user's employer, who may offer the user a reward in response to a sensed bicycle commuting trip made by the user to incentivize bicycle commuting. In another scenario, an offering party 126 may be a personal hygiene product manufacturer, who may offer the user a coupon for dental floss in response to sensed oral hygiene behavior of the user. It will be understood that any suitable offering party 126 may make offers to the user in response to sensed behavioral action via behavior reward system 100 without departing from the scope of the present disclosure.

Offers may be generated at offering party 126 and/or at server computing device 106. Regardless of where the offer is generated, server computing device 106 supplies offers to the user, receives offer selections (e.g., offer acceptances or offers by the user) from the user, and may manage message traffic between offering party 126 and client computing device 116.

While the examples described herein refer to an offer being communicated to the user and to the user communicating an offer selection manifesting acceptance to the offering party, it will be appreciated that other suitable exchanges of agreements may be performed without departing from the scope of the present disclosure. For example, in some embodiments, offering party 126 may provide a promotional opportunity to the user via server computing device 106 that invites the user to make an offer, via an offer selection of the user, which offering party 126 may accept or reject.

Offers are supplied by server computing device 106 to client computing device 116. Client computing device 116 includes a logic subsystem 120, a data-holding subsystem 122, and a display subsystem 118, and is configured to read from and/or write to removable computer readable media 124. Logic subsystem 120 is configured to execute instructions stored in the data-holding subsystem 122 to implement the instructions for performing various methods described herein. Client computing device 116 may be any suitable computing device. Non-limiting examples of client computing device 116 include a mobile and/or wireless computing device, a networked computer, or a kiosk-type device.

Client computing device 116 also includes a user interface 121 for receiving input from the user and for displaying information to the user. For example, in one scenario, a user may view information about the user's energy consumption and savings, as detected by sensors 102, via user interface 121. A score and/or a score value related to the sensed behavioral action of the user may be presented to the user via user interface 121. User interface 121 may also present historical information for the user's sensed behavioral actions (e.g., accumulated scores and/or score values, instances of one or more sensed behavioral actions over a time interval, etc.) that may incentivize the behavioral action and/or inform the user of potential “backsliding” into old habits. User interface 121 may be presented in any suitable way. Non-limiting examples of user interface 121 include user-customizable and/or personalized web pages, SMS text messages, TWITTER-style feeds, and email alerts displayed by client computing device 116.

The user may receive and select offers via user interface 121. The user may also configure aspects of behavior reward module 112 via user interface 121. For example, a user may associate a score with a behavioral action, such as assigning a score for commuting a predetermined distance by bicycle. In some embodiments, user interface 121 may be presented via display subsystem 118 though it will be appreciated that user interface 121 may be presented to a user via any suitable presentation hardware.

As shown in FIG. 1, communication among the various computing devices of behavior reward system 100 is handled by network 128. It will be understood that sensors 102, gateway computing device 104, server computing device 106, client computing device 116, and computing devices included in offering parties 126 may include suitable communication subsystems configured to communicatively couple with one or more other computing devices. Such communication subsystems may include wired and/or wireless communication devices compatible with one or more different communication protocols. Some non-limiting examples include wireless telephone networks (e.g., cellphone networks), a wired local area network (LAN), a wired wide area network (WAN), wireless LANs and/or WANs, and so on. In some embodiments, the communication subsystems may allow the computing devices to send and/or receive messages to and/or from other computing devices via the Internet.

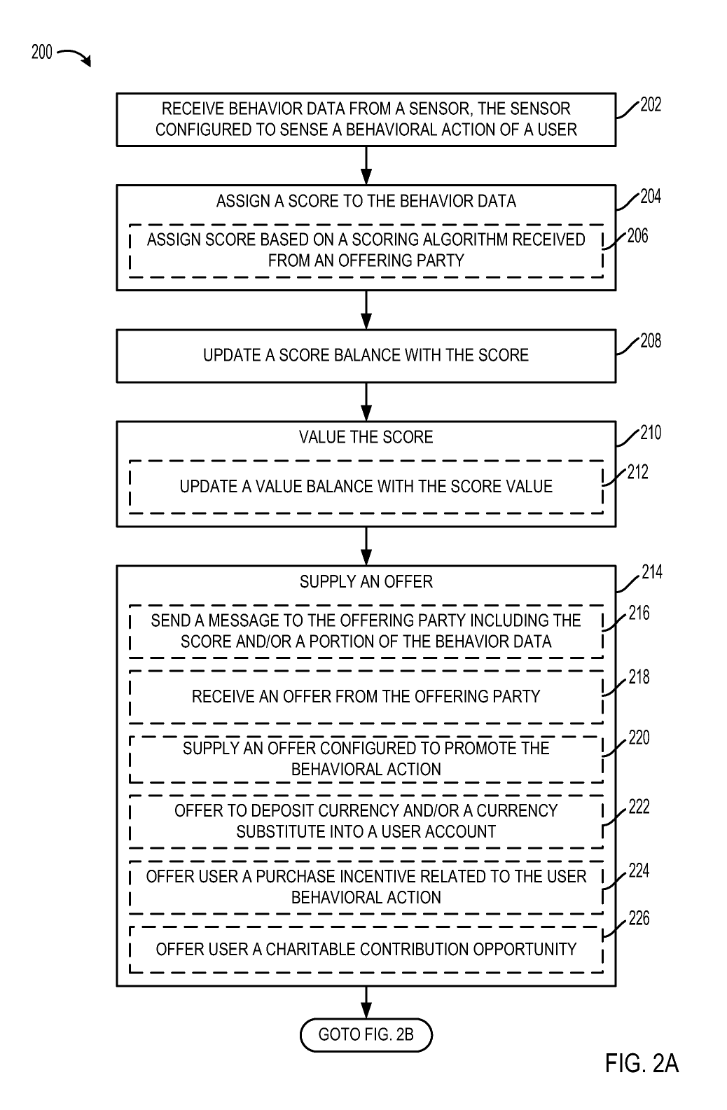

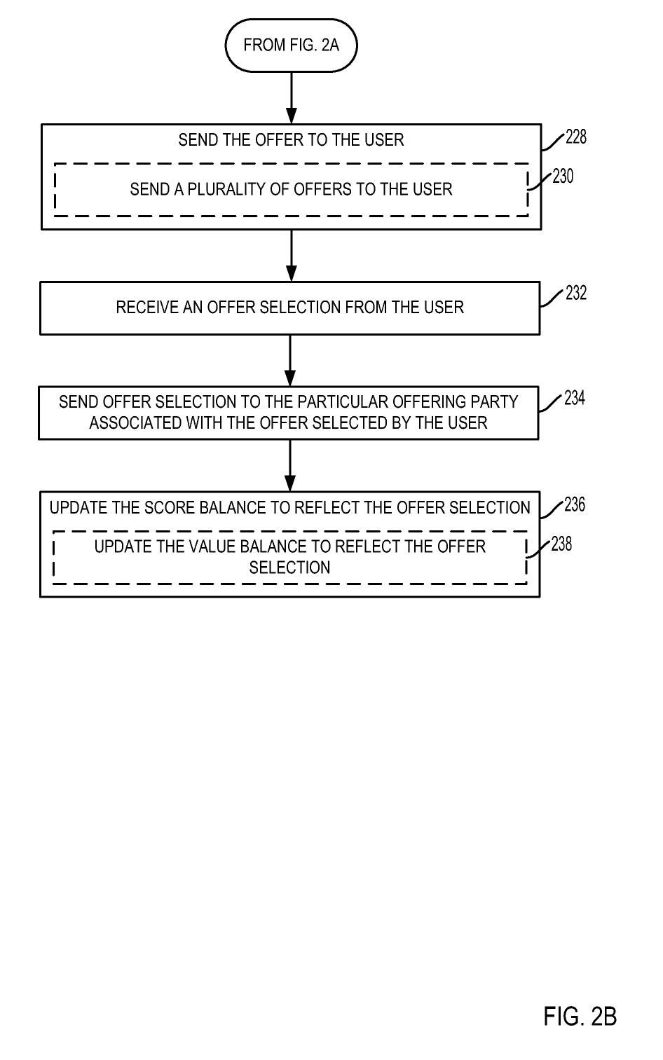

FIGS. 2A and 2B illustrate a flow chart for an embodiment of a method 200 for positively reinforcing a user behavior. Method 200 may be performed by any suitable hardware, such as the hardware shown in FIG. 1 and FIG. 3.

Method 200 comprises, at 202, receiving behavior data from a sensor, the sensor configured to sense a behavioral action of a user. At 204, method 200 comprises assigning a score to the behavior data. Using the score, the behavior reward system and/or the offering party may adapt the offer to the detected behavior. For example, some behavioral actions may score higher than some other behavioral actions and may be rewarded with a comparatively more attractive offer. The score may be assigned in any suitable way. In some embodiments, the score may be assigned according to a user-configurable algorithm. For example, the user may configure the score to be proportional to a duration of the behavioral action.

In some embodiments, assigning the score 204 may comprise, at 206, assigning the score based on a scoring algorithm received from an offering party. In one scenario, the offering party may provide a formula used by the behavior reward system to translate the detected behavioral action into a score. For example, in a scenario where bicycle commuting is the behavior being detected and scored, a scoring algorithm may generate a score based on a number of miles that the user commutes by bicycle, based on an amount of fuel that the user saves as a result of not driving, and/or based on a duration for which the user's heart rate exceeded a predetermined threshold during the commute.

At 208, method 200 comprises updating a score balance with the score. Thus, the behavior reward system may accumulate and track scores from the user's behavioral activities. This may provide a convenient way for the user to keep track of the user's progress without manually logging the user's progress.

At 210, method 200 comprises valuing the score. In some embodiments, valuing the score may include assigning a monetary value to the score. In some embodiments, the score may be valued arbitrarily. For example, instances of brushing and flossing teeth may be assigned a preconfigured monetary value. Alternatively, in some embodiments, the score may be valued in relation to a value of the behavior detected. For example, the score for commuting by bicycle may be assigned a value corresponding to fuel savings.

In some embodiments, valuing the score 210 may comprise, at 212, updating a value balance with the score value. Thus, a user may, over time, accumulate value in an account based on the user's performance of the behavioral action. This may incentivize the user to continue performing the behavioral action, potentially decreasing a chance that the user may fall back into old habits.

At 214, method 200 comprises supplying an offer to be sent to the user. The offer is provided by an offering party responsive to the detected behavioral action. As explained above, the offer may be any suitable offer related to rewarding and incentivizing the sensed behavioral action, including offers of goods or services, monetary incentives and/or monetary discounts, sale promotions, and/or competition incentives and prizes. Some non-limiting examples of suitable offers are described below.

In some embodiments, the offer may be generated by the offering party. In such embodiments, supplying the offer at 214 may comprise, at 216, sending a message to the offering party. The message may include one or more of the score, the score balance, and a portion of the behavior data, or any other suitable content (e.g., a user identifier, a time stamp, a date stamp, etc.) that the offering party may use when generating the offer. In such embodiments, supplying the offer 214 further comprises, at 218, receiving the offer from the offering party. Additionally or alternatively, in some embodiments, the offer may be generated at the server computing device according to algorithms or conditions provided by the offering party.

In some embodiments, the offer may be suitably related to the behavioral action detected by the sensors. For example, in some embodiments, supplying the offer 214 may comprise, at 220, supplying an offer configured to promote the behavioral action. Thus, in one scenario, a detected bicycle trip by the user may lead a bicycle retailer to offer free or discounted bicycle maintenance or bicycle supplies if the user commutes a predetermined distance by bicycle. In another scenario, a bicycle enthusiast organization may offer the user an opportunity to participate in organized bicycle riding activities or to have the user's bicycle-riding activity logged and displayed on a leaderboard as a way of encouraging future bicycle activity in the user and/or in others. In a scenario where the sensed behavioral action is an oral hygiene activity (e.g., flossing, brushing, etc.), the user's dentist may provide a discounted future office visit if the user flosses and brushes two or more times per day.

While the offers described above may also be related to sales promotion, it will be understood that any suitable offer configured to promote the behavioral action may be employed without departing from the scope of the present disclosure. For example, the offering party may offer an interactive avatar, a special ringtone, membership in an organization or an online interactive community to the user.

In some embodiments, supplying an offer at 214 may comprise, at 222, offering to deposit currency and/or a currency substitute into a user behavior reward account. In some embodiments, an offering party may offer to deposit money into a user's personal account, such as a checking account, a retirement account, or an equity account in response to a detected behavioral activity. For example, the employer may elect to share a reduction in the user's health insurance premiums related to the user's healthy lifestyle and/or to share a reduction in parking and/or transit costs realized by the user's commuting choice as an approach to incentivizing the user's bicycle-riding behavior. In this example, the user's employer may offer to deposit money into a user's account in response to commuting a predetermined distance by bicycle. While this scenario relates to a cash-based incentive, it will be appreciated that suitable credit-based incentives may be employed as well. For example, the offering party may offer a gift card or other stored value card to the user in response to the user's behavioral action, may offer to make a contribution to a user's frequent-flier mileage account in response to the user's behavioral action, or the like.

In some embodiments, supplying the offer may comprise, at 224, offering a purchase incentive related to the user behavioral action. For example, the offer may be a sales promotion generated in response to the user behavioral action. As described above, a bicycle retailer may offer a discount on bicycle-related goods or services in response to the user behavioral action. A consumer products manufacturer may offer the user a discount on toothpaste as the user's current tube is emptied, or may offer the user a free trial supply of a new oral hygiene product related to the behavioral activity. Thus, suitable purchase incentives may include coupons, reduced cost samples, and rebates or other suitable reward tokens.

In some embodiments, supplying the offer 214 may comprise, at 226, offering the user an opportunity to make a charitable contribution. The charitable contribution may be made in any suitable way. For example, in some embodiments, the offering party may be a charity, while in some other embodiments, the offering party may offer the user the opportunity to make a contribution to a separate charitable entity. Further, in some embodiments, the offering party may offer the user the opportunity to make a contribution on the offering party's behalf. For example, in a scenario where the offering party is the user's employer, the employer may offer the user the opportunity to select a charity to receive a donation from the employer in response to the user's performance of a behavioral action.

Turning to FIG. 2B, method 200 comprises, at 228, sending the offer to the user, the offer being configured to be displayed on a client computing device. As explained above, the user may access a user interface displayed on a client computing device, such as a mobile phone, laptop, or kiosk. Offers supplied to the user are displayed via the user interface for the user's consideration. Thus, the user may access and interact with the user's behavior reward account and/or stored value card via the user interface displayed on the client computing device. This may provide the user an opportunity to easily track the user's behavioral activities, select offers the user is interested in accepting, and realize the benefits of the offers the user has accepted via a convenient behavior reward system interface. In some embodiments, sending the offer to the user 228 may comprise, at 230, sending a plurality of offers to the user, the offers being provided by one or more offering parties. Thus, the user may choose to accept one or more offers from one or more offering parties.

At 232, method 200 comprises receiving an offer selection from the user, and, at 234, sending the offer selection to the particular offering party associated with the offer selected by the user. Thus, in one example, a user's selection of a coupon offer from a manufacturer and a free music download offer from a retailer may be conveniently managed by the user from the user interface, and centrally administered by the server computing device. This may allow the user to avoid unpleasant experiences where the user is bombarded by separate emails and popups from several sources.

In some embodiments, centrally administering the offers and the offer selections may provide a basis for developing a user profile reflecting the user's interests. If the user elects to share the user profile with offering parties, the offering party may be able to customize offers to the user's interests.

As explained above, in some embodiments, a user may accumulate a score and/or a score value balance over time based on the user's detected behavioral actions, so that the user behavioral action may be tracked by the user, and so that the user may be encouraged to continue a particular behavioral action in the future. In some of those embodiments, the user's account may act as an exchange where accumulated scores and/or score value may be traded for reward opportunities. Thus, in some embodiments, the offering party may provide the user with an offer responsive to the user behavioral action and exchange for some of the user's accumulated score and/or score value. For example, an offering party may provide the user with an offer for credit at an e-commerce platform or online retailer (which may be the offering party's own platform, or may be a platform for a different party) in exchange for a portion of the user's accumulated reward points or reward earnings. In such embodiments, the user's account may be updated responsive to the user's selection of an offer. Thus, in some embodiments, method 200 may comprise, at 236, updating the score balance to reflect the offer selection, and/or, at 238, updating the value balance to reflect the offer selection. For example, in some embodiments, an offer price associated with the offer selection may be deducted from the value balance.

It will be appreciated that any suitable sensors may be used with embodiments of the behavior reward system and method disclosed herein without departing from the scope of the present disclosure. Non-limiting examples of suitable sensors include low power and self-powered sensors that may be attached to any suitable object, such as moveable objects (e.g., bicycles, toothbrushes, dental floss containers, etc.) and stationary objects (e.g., gym equipment, heating and air conditioning equipment, water heaters, etc.).

In some embodiments, sensor 102 may be removably attached to an object (e.g., a sensor sticker affixed to a tube of toothpaste), or otherwise compact and portable (e.g., a sensor affixed to a hub of a bicycle). In some embodiments, sensor 102 may be stationary (e.g., a sensor affixed to a hot water heater). Further, while some of the sensors described herein are standalone sensors, in some embodiments, sensor 102 may be integrated into another device (e.g., a home temperature control station, an automobile electronic control system, etc.).

For example, FIG. 3 schematically shows an embodiment of a sensor 102 configured to sense a user's behavioral action. Sensor 102 may be configured in any suitable way. For example, in some embodiments, sensor 102 may be packaged in a sealed flexible housing and may include an adhesive or other bonding material configured to removably or permanently affix sensor 102 to an object that the user interacts with so that the user's behavioral activity is detected by sensor 102. For example, sensor 102 may be a “puffy” style sticker, having a raised bubble encapsulating the sensor computing device and having an adhesive on one surface. One non-limiting example of such a sensor sticker has dimensions of approximately 40 mm high×2 mm deep×28 mm wide. In some examples, such sensor stickers may have shapes and colors configured to make them attractive to the user. In some non-limiting examples, a sensor sticker configured to be attached to a child's toothpaste tube may be shaped and colored so that the sensor sticker resembles a giraffe, an alligator, or a bunny.

As shown in FIG. 3, sensor 102 is a computing device comprising a data-holding subsystem 312 and a logic subsystem 304. The example sensor 102 shown in FIG. 3 also includes an on-board power supply 310 and a transmitter 308. Power supply 310 may be any suitable local power supply, such as a battery, an energy-harvesting device, or a photovoltaic power supply. In some embodiments where sensor 102 remains in a fixed location (for example, in a user's home or car), power supply 310 may be a plug-in power adapter or otherwise receive power from the location (e.g., a wall outlet or an automotive power supply in the examples described above). Transmitter 308 may be any suitable transmission device for sending messages to the server computing device. For example, in some embodiments, transmitter 308 may be a wireless transmitter configured to wirelessly communicate with the server computing device over one or more of a local wireless network, a cellphone network, or a wireless Internet connection.

The embodiment of sensor 102 shown in FIG. 3 includes a sensor package 302 which may comprise one or more sensor devices 303 for sensing a user behavioral action. Non-limiting examples of sensor devices 303 include accelerometers, photosensors, acoustic sensors, pressure sensors, thermal sensors, and contact sensors. In some embodiments, sensor package 302 may comprise a plurality of suitable sensor devices 303 of the same or different type.

Sensor 102 includes a behavior sensing module 314 for receiving sensor signals from sensor package 302 and for generating messages for transmission to server computing device 106 via transmitter 308. For example, in some embodiments, behavior sensing module 314 may generate messages including instructions that behavior reward system 100 register a reward condition based on signals indicating that a behavioral activity has been performed. Additionally, in some embodiments, the messages may include message metadata, such as sensor identifiers and/or transmission timestamps.

In some embodiments, sensor 102 may include a radio frequency identification device (RFID) reader 306. RFID reader 306 may read an RFID tag (not shown) carried by the user so that sensor 102 may associate the sensed behavioral action with a particular user. This may allow a single sensor 102 to detect behavioral actions of more than one user. Behavior sensing module 314 may include information about the particular user, such as a user identifier, in the message sent to the server computing device.

As explained above, the various computing devices described herein include suitable logic and data-holding subsystems. In some embodiments, the computing devices may also include suitable computer readable media and display subsystems.

Suitable logic subsystems may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

The data-holding subsystem may include one or more physical, non-transitory, devices configured to hold data and/or instructions executable by the logic subsystem to implement the herein described methods and processes. When such methods and processes are implemented, the state of the data-holding subsystem may be transformed (e.g., to hold different data).

The data-holding subsystem may include removable computer-readable media and/or built-in devices. The data-holding subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Removable computer-readable media may include CDs, DVDs, HD-DVDs, Blu-Ray Discs, EEPROMS, and/or floppy disks, among others.

The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit or a system on a chip.

It will be understood that the data-holding subsystems described herein include one or more physical, non-transitory devices. In contrast, in some embodiments, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The term “module” may be used to describe an aspect of the various computing devices disclosed herein that is implemented to perform one or more particular functions. In some embodiments, such a module may be instantiated via the logic subsystem executing instructions held by the data-holding subsystem. It will be understood that different modules may be instantiated from the same application, service, code, application programming interface, etc. The same module may be instantiated by different applications, services, codes, application programming interfaces, etc. The term module is meant to include individual or groups of executable files, data files, libraries, drivers, scripts, database records, etc.

When included, the display subsystem may be used to present a visual representation of data held by the data-holding subsystem. As the methods and processes described herein change the data held by the data-holding subsystem, the state of the display subsystem may be transformed to represent the changes in the underlying data visually. The display subsystem may include one or more display devices utilizing virtually any type of technology. Such display devices may be combined with the logic subsystem and/or the data-holding subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. At a server computing device, a method for positively reinforcing user behavior based on information received from a sensor, the method comprising:
receiving behavior data from a sensor configured to sense a user behavioral action;
responsive to the behavior data, using a logic subsystem of the server computing device to supply an offer configured to reward the user behavioral action; and
sending, from the server computing device, the offer to the user.

2. The method of claim 1, wherein supplying the offer further comprises:
sending a message to an offering party, the message including at least a portion of the behavior data; and
receiving the offer from the offering party.

3. The method of claim 1, further comprising, prior to supplying the offer, assigning a score to the behavior data and generating the offer based on the score.

4. The method of claim 3, further comprising:
sending a plurality of offers to the user from one or more offering parties;
receiving an offer selection from the user; and
sending the offer selection to the particular offering party associated with the offer selection.

5. The method of claim 3, wherein the score is assigned based on a scoring algorithm received from an offering party.

6. The method of claim 3, further comprising valuing the score as one of a currency and a currency substitute.

7. The method of claim 3, wherein supplying the offer comprises one of offering to deposit currency and/or a currency substitute into a user account, offering the user a purchase incentive, and offering the user a charitable contribution opportunity.

8. The method of claim 7, wherein the offer is the purchase incentive for a product and/or a service, wherein the product and/or the service is related to the user behavioral action.

9. The method of claim 1, wherein the sensor is a wireless sensor configured to detect the user behavioral action and to transmit the behavior data to a server computing device.

10. The method of claim 1, wherein sending the offer to the user comprises sending the offer for display to the user via a user interface of a client computing device.

11. A server computing device for positively reinforcing behavioral actions, comprising:
a data-holding subsystem;
a logic subsystem; and
a behavior reward module held at the data-holding subsystem and executed by the logic subsystem, the behavior reward module comprising instructions to:
from a sensor, receive behavior data for a user behavioral action,
responsive to the behavior data, supply an offer configured to incentivize a change in the user behavioral action; and
send the offer to a client computing device for display to the user.

12. The server computing device of claim 11, wherein the instructions to supply the offer further comprise instructions to:
responsive to the behavior data, send a message to an offering party, the message including at least a portion of the behavior data, and
receive the offer from the offering party.

13. The server computing device of claim 11, further comprising instructions to:
assign a score to the behavior data, and
supply the offer based on the score.

14. The server computing device of claim 13, further comprising instructions to:
present a plurality of offers to the user from one or more offering parties;
receive an offer selection from the user;
send the offer selection to the particular offering party associated with the offer selection; and
update a score balance to reflect the offer selection.

15. The server computing device of claim 13, further comprising instructions to assign the score based on a scoring algorithm received from an offering party.

16. The server computing device of claim 13, further comprising instructions to value the score as one of currency and a currency substitute.

17. The server computing device of claim 11, wherein the offer is related to the user behavioral action.

18. A client computing device, comprising:
a display;
a user interface configured to receive input from a user;
a data-holding subsystem; and
a logic subsystem configured to execute instructions held by the data-holding subsystem, the instructions configured to:
receive a plurality of offers from a server computing device, the offers being provided by one or more offering parties responsive to a sensed user behavioral action,
display the offers to the user,
receive an offer selection from the user via the user interface, and
send the offer selection to the server computing device.

19. The client computing device of claim 18, wherein the user score includes a score supplied responsive to the user behavioral action, the user behavioral action being detected by a sensor that wirelessly communicates with the server computing device.

20. The client computing device of claim 18, wherein the offer is related to the user behavioral action.
